(19) United States
(12) Patent Application Publication
(10) Pub. No.: US 2011/0107757 A1
(43) Pub. Date: May 12, 2011

(54) STIRLING ENGINE

(75) Inventor: Klaus Engelhart, Hobenbach (AT)

(73) Assignee: VKR HOLDING A/S, Horsholm (DK)

(21) Appl. No.: 12/933,124

(22) PCT Filed: Mar. 19, 2009
(86) PCT No.: PCT/EP2009/053237

§ 371 Date: Dec. 7, 2010

(30) Foreign Application Priority Data
Mar. 20, 2008 (AT) A 444/2008

(51) Int. Cl. F02G 1/057; F02G 1/053

(52) U.S. Cl. 60/526; 60/517

(57) ABSTRACT

The invention relates to a Stirling engine, including at least one cylinder in which two pistons are arranged which move counter to one another, with each piston being connected by means of a first connecting rod to an oscillating lever, and the oscillating lever is connected by means of a second connecting rod to the crankshaft, where the oscillating lever is connected in an articulated manner with its first end to the second connecting rod, it is pivotably mounted at its second end in the cylinder housing, and the first connecting rod is connected in an articulated manner between the first and second end.

### TECHNICAL FIELD

The invention relates to a Stirling engine, comprising at least one cylinder in which two pistons are arranged which move counter to one another, with each piston being connected by means of a first connecting rod to an oscillating lever, and the oscillating lever is connected by means of a second connecting rod to the crankshaft.

### BACKGROUND

A Stirling engine is a work machine in which heat is supplied from the outside to a cylinder, or is discharged by a cylinder. It is possible to operate the machine as an engine, with a working medium being cooled and heated in an alternating fashion in a cycle process in order to generate mechanical work. Conversely, a Stirling engine can also be used as a refrigerating machine, in which heat is brought from a lower temperature level to a higher temperature level by applying mechanical work. It is possible to cover both fields of application within the scope of the present invention.

It is known to arrange Stirling engines in form of opposed piston machines. Two pistons move against one another in a common cylinder space or a cylinder arrangement, which pistons are a compression piston and an expansion piston. Regenerator and heat exchanger are arranged between the pistons in order to heat and cool the working gas in an alternating fashion during the operation of the machine. The advantage of this configuration is that very large transfer cross sections can be represented, so that high efficiencies can also be achieved at low temperature differences.

An internal combustion engine in opposed-piston configuration is known from GB 2 030 213 A. The pistons are in connection with a crankshaft arranged laterally between the pistons via a first connecting rod, an oscillating lever and a second connecting rod. It is similarly possible to arrange Stirling engines. In the case of connecting rods that are arranged in a respectively long way, the distance/time diagram of the piston movement substantially corresponds to a sine curve. As a result of the geometry of the crank drive, there is a deviation from the sine curve which is the larger the shorter the connecting rod is in relation to the crank throw. In the opposed-piston configuration as described above, this deviation ensures that the piston moves relatively quickly in the region of the upper dead centre, whereas it remains in the region of the bottom dead centre for a relatively long period of time. It has been noticed that this movement pattern is relatively unfavourable for Stirling engines, leading to losses in the efficiency.

Moreover, the known solution has further disadvantages. As a result of the direct connection of oscillating lever and piston on the one hand and the linkage to one end of the oscillating lever on the other hand, lateral forces act upon the piston as a result of this geometry. Since the pistons in a Stirling engine will always run dry in contrast to an internal combustion engine, these lateral forces have a highly negative effect, especially on the sealing behaviour and the service life of the pistons.

### BRIEF SUMMARY

The invention avoids the described disadvantages and to provide a Stirling engine in which high efficiency can be achieved even at small temperature differences.

This is achieved in accordance with the invention in such a way that the oscillating lever is connected in an articulated manner with its first end to the connecting rod, it is pivotably mounted at its second end in the cylinder housing, and the first connecting rod is connected in an articulated manner between the first and second end. The relevant aspect in the present invention is the fact that as a result of the changed geometry of the crank drive a lower dwell time of the piston is achieved in the upper dead centre, in combination with a simultaneous faster movement in the region of the bottom dead centre. It is thus possible to achieve higher efficiencies. A further advantage of the present invention lies in the manner of introduction of forces on to the piston.

As a result of this kind of connection of the piston with the crankshaft, virtually no lateral forces act upon the piston, so that the realization of larger piston diameters and, consequently, a larger cylinder volume are enabled. A higher gas volume also means higher efficiency.

In a preferred embodiment of the invention, the oscillating lever comprises two sections which are aligned at an angle in relation to one another, with preferably the first connecting rod being connected in an articulated manner to the longer section. This arrangement of the oscillating lever allows an especially compact configuration of the Stirling machine.

In order to further reduce the lateral forces acting upon the piston, the end of the longer section of the oscillating lever advantageously comprises two projections via which the oscillating lever is connected in an articulated manner with the cylinder housing.

In an especially preferred embodiment of the invention, the oscillating lever is arranged in an integral manner. This reduces the number of the individual parts of the oscillating lever, which again extends the service life of the oscillating lever and reduces its production costs.

A further increase in the efficiency is achieved when the second connecting rod is provided with a short configuration, especially when its length is shorter than three times the crank throw. The shorter the connecting rod, the stronger a deviation from the sine progression of the piston movement and the higher the efficiency of the Stirling engine in accordance with the invention.

A Stirling engine usually comprises a heat exchanger which is used for cooling or heating the gas in the cylinder chamber. An improved heat exchange, and thus a further improvement of the efficiency, is provided when each piston is associated with a separate heat exchanger which are arranged to be spaced from one another in the cylinder housing between the pistons.

The heat exchanger preferably comprises ribs which are made of aluminium and are spaced from one another via embossed knobs. This form of heat exchanger has proven to be especially advantageous for the flow behaviour of the gas. The production of the heat exchanger is especially cost-effective when it has a rectangular or square shape.

It is especially advantageous for the efficiency of the Stirling engine in accordance with the invention when a regenerator is arranged between the heat exchangers. This insert which is made of a screen-like, porous or sponge-like material is used for absorbing and storing a part of the heat of the hot gas that flows through the same in order to emit this heat again to the cooled gas when it flows again in the opposite direction.

Hydrogen is preferably used as a gas. It is also possible to use other gases or gas mixtures such as helium or air. Hydrogen offers the advantage of large thermal capacity and good heat transfer, thus improving the efficiency of the Stirling engine. However, it needs to be treated with extreme care because of its highly exothermal reaction with air or oxygen. That is why a preferred embodiment of the invention comprises a pressure-tight housing in which the cylinder is housed jointly with the crank drive in an encapsulated manner. A very high excess pressure prevails within this housing, e.g. 30 bar, whereas pressures of 30±5 bar prevail within the cylinder for example. As a result, the seals of the cylinder, and especially the piston seals, merely need to withstand a pressure difference of 5 bar over the excess pressure prevailing within the housing, whereas the sealing of 30 bar against the ambient pressure is provided by the housing seals. This sealing of the housing against the ambient pressure can be obtained in a very simple and cost-effective way in comparison with sealing by moved parts.

### BRIEF DESCRIPTION OF THE DRAWINGS

The invention is now explained in closer detail by reference to a non-limiting embodiment with the pertinent drawings, wherein:

FIG. 1 shows an oblique view of a Stirling engine in accordance with the invention;

FIG. 2 shows an oblique view of the Stirling engine of FIG. 1 without the housing;

FIG. 3 shows a sectional view of the Stirling engine of FIG. 2 with heat exchanger;

FIG. 4 shows an oblique view of the heat exchanger of FIG. 3;

FIG. 5 shows the curve progression of the piston movement;

FIG. 6 shows a further embodiment of the invention in a front view;

FIG. 7 shows an oblique view of the Stirling engine of FIG. 6, and

FIG. 8 shows a further oblique view of the rear side of the Stirling engine of FIG. 6.

### DETAILED DESCRIPTION

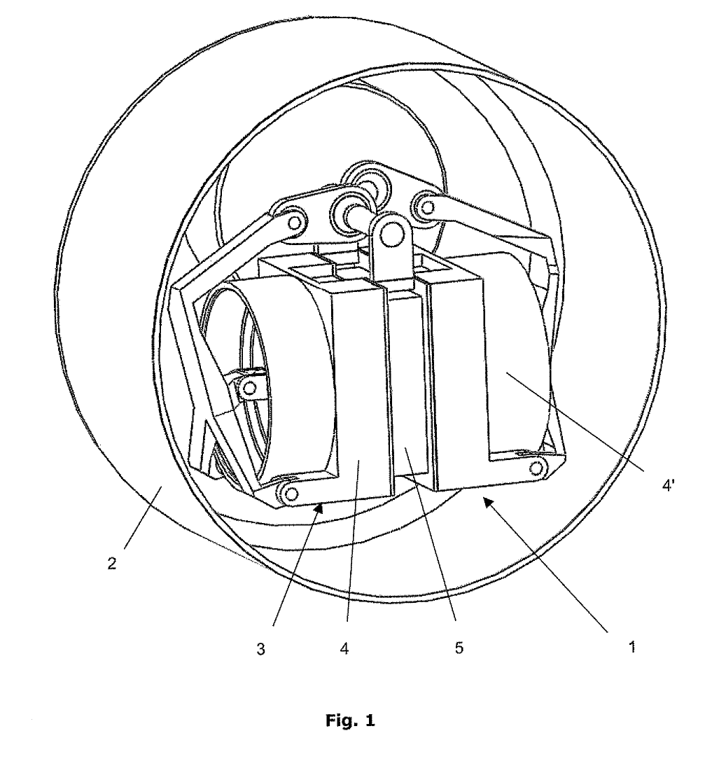

As is shown in FIG. 1, the Stirling engine 1 in accordance with the invention is housed in an engine housing 2 and comprises a cylinder housing 3 which is composed of two symmetrical cylinder halves 4, 4′. These identical cylinder halves 4, 4′ are connected with one another in a gas-tight manner via a connecting part 5.

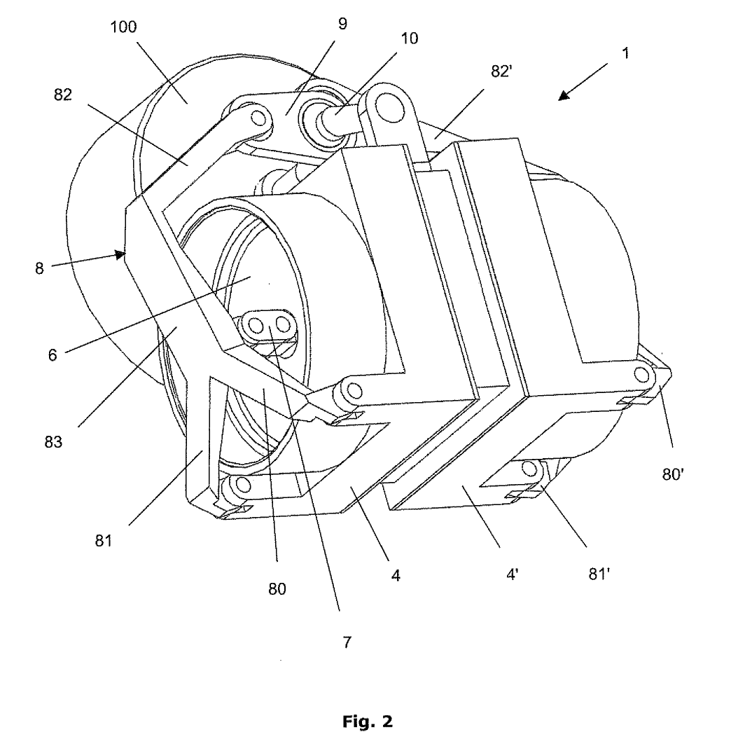

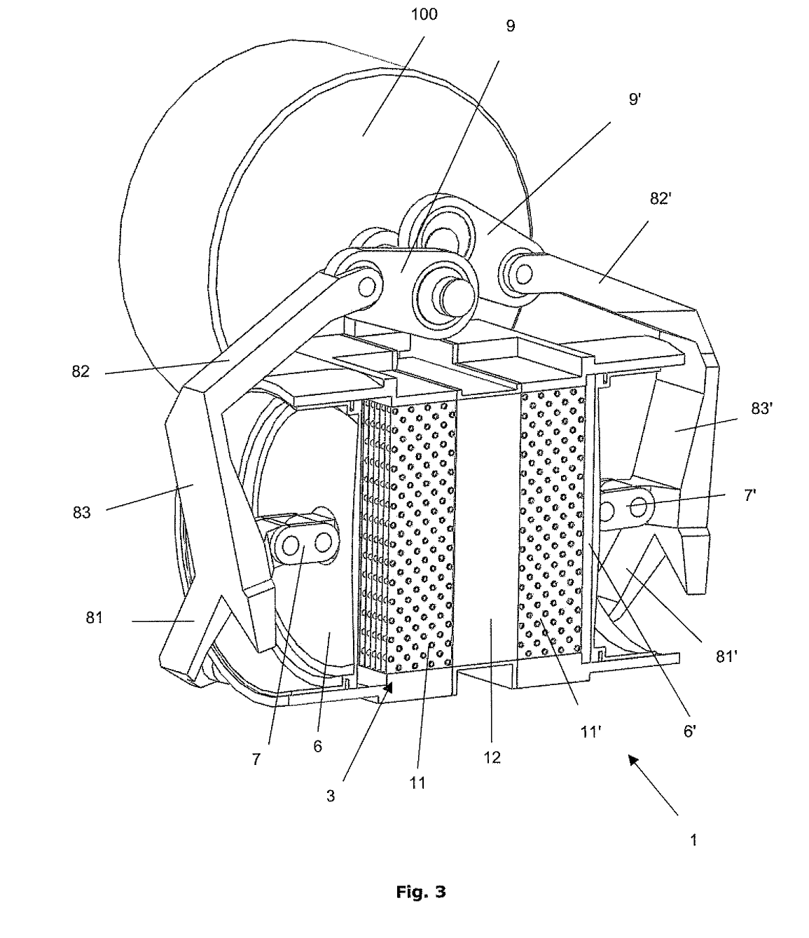

In accordance with FIGS. 2 and 3, a piston 6, 6′ is movably arranged in each cylinder half 4, 4′. The piston 6, 6′ is connected via a first connecting rod 7 with an oscillating lever 8, with the oscillating lever 8 ending in the illustrated embodiment of the invention in two projections 80, 81 at its end on the piston side. The oscillating lever 7 is pivotably mounted via these projections 80, 81 on the cylinder half 4.

The other end of the oscillating lever 8 is connected with a second connecting rod 9, which on its part is coupled with a crankshaft 10, with the crankshaft 10 driving a generator 100.

The oscillating lever 8, 8′ is integrally arranged with two sections 82, 82′, 83, 83′ which are arranged at an angle of approx. 90° in relation to one another and act as lever arms. The oscillating lever 8, 8′ is connected on the shorter lever arm 82, 82′ via the second connecting rod 9, 9′ with the crankshaft 10. The longer lever arm 83, 83′ is connected on the one hand with its end via projections 80, 80′, 81, 81′ with the respective cylinder half 4, 4′ and on the other hand via the first connecting rod 7, 7′ with the piston 6, 6′.

As a result of this arrangement of the oscillating lever 8, 8′, virtually no lateral forces act upon the dry-running pistons 6, 6′ as a result of the knee lever kinematics, so that the service life of the slide bearing is extended substantially. Furthermore, the use of a shorter piston skirt is enabled, through which the weight of the piston 6, 6′ is reduced on the one hand and the costs for the piston 6, 6′ on the other hand. In addition, the ratio of the oscillating lever 8, 8′ enables large piston forces and thus large piston diameters, so that again a larger gas volume can be used in combination with improved flow behaviour in the cylinder 3. The most even flow behaviour leads to an improved efficiency. As a result of the low piston stroke, as seen in relation to the piston cross section, the relative speed of the employed slide bearings will be reduced, leading to an extension of their service life and to a reduction in the gas friction losses.

Each cylinder half 4, 4′ includes on the one hand of a region with a circular cross section in which the piston 6, 6′ can be reciprocated, and a region with a rectangular, preferably square, cross section which is provided for accommodating a heat exchanger 11, 11′. A regenerator 12 is additionally arranged in the connecting part 5 between the two heat exchangers 11, 11′, which regenerator is usually made of a porous and/or sponge-like material and is used for storing heat.

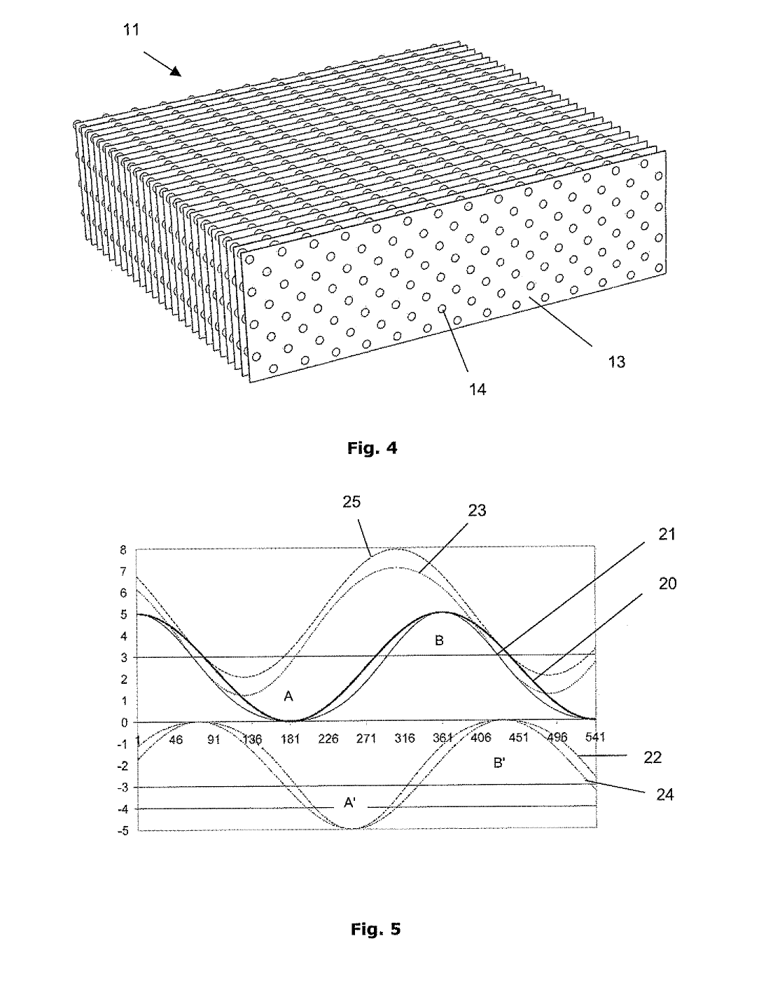

A heat exchanger 11 which can be used in the Stirling machine 1 in accordance with the invention is shown in FIG. 4. This heat exchanger 11 comprises aluminium plates 13 which are soldered together, e.g. with the dimensions 140×40×0.2 mm, which are spaced from one another by knobs 14 which are embossed in the plate with a height of 0.2 mm for example. Inserted pipes which are also soldered thereon produce an additional heat flow between the media. Its production is especially simple and cost-effective as a result of the rectangular shape of the heat exchanger. It has been noticed that despite the circular cross section of piston 6, 6′, favourable inflow is provided, especially when the surface of the piston 6, 6′ corresponds to that of the rectangular inflow area of the heat exchanger 11, 11′.

As a result of the symmetrical arrangement of the cylinder halves 4, 4′ with their pistons 6, 6′ and the associated heat exchangers 11, 11′, the number of the different components of the Stirling machine 1 decreases and thus also the costs for the production of the same. The compact configuration of the cylinder 3 is further advantageous for hermetic sealing, which is especially important in cases where hydrogen is used as a working gas in the cylinders.

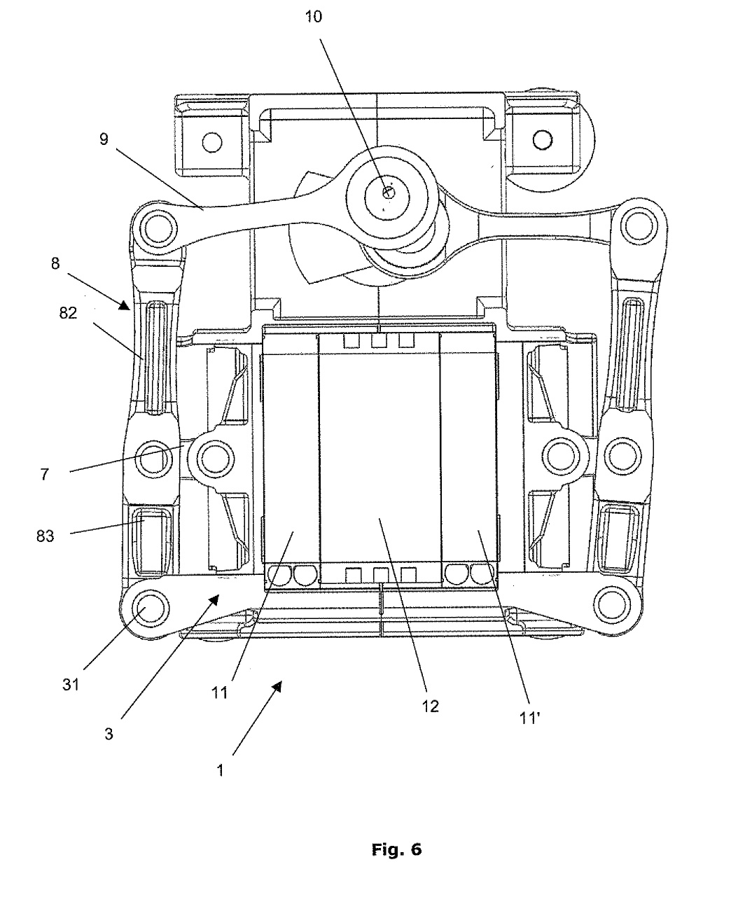

The piston movements within the Stirling engine 1 during the operation of the same are shown in the diagram according to FIG. 5.

The line designated with reference numeral 21 describes the sinusoidal progression of the piston movement of the so-called expansion piston 6, which is the piston which works in the heated part of the Stirling engine 1. It can clearly be recognized that the curve progression deviates from the ideal sinusoid 20. The curve progresses flatter in the region A of the upper dead centre, i.e. the piston remains longer at the upper dead centre, whereas the curve in region B of the bottom dead centre extends more steeply and thus remains shorter in this position. This distortion of the sine progression of the piston movement can be influenced relevantly by the length of the second connecting rods 9, 9′. The shorter the second connecting rods 9, 9′, the stronger the distortion. As a result of this approximation to a process progressing in a discontinuous manner in the theoretical ideal case, efficiencies can be achieved which are higher than those of the Stirling engines disclosed in the state of the art.

The point is designated as bottom dead centre where the piston 6, 6′ has its largest distance to the heat exchanger 11, 11′, whereas the piston 6, 6′ nearly touches the heat exchanger 11, 11′ in the upper dead centre.

The curve progression 22 of the compression piston 6′ on the other hand shows a flattened portion in the region B′ of the upper dead centre and a shorter dwell time in the region A′ of the bottom dead centre, which means it has a behaviour running similarly in relation to the expansion piston 6. In addition to the movement offset by 180°, the piston movement is displaced by a phase angle of 72° (shown in the abscissa).

The line designated with reference numeral 25 describes the change of the total volume of the gas within the cylinder during the heating and cooling phase. When the expansion piston 6 is at the bottom dead centre, the gas is heated and its volume increases. Its volume decreases by compression when the expansion piston 6 approaches its upper dead centre. At the same time, the gas is displaced to the cooling zone, cools off and its volume decreases while the compression piston 6′ moves upwardly.

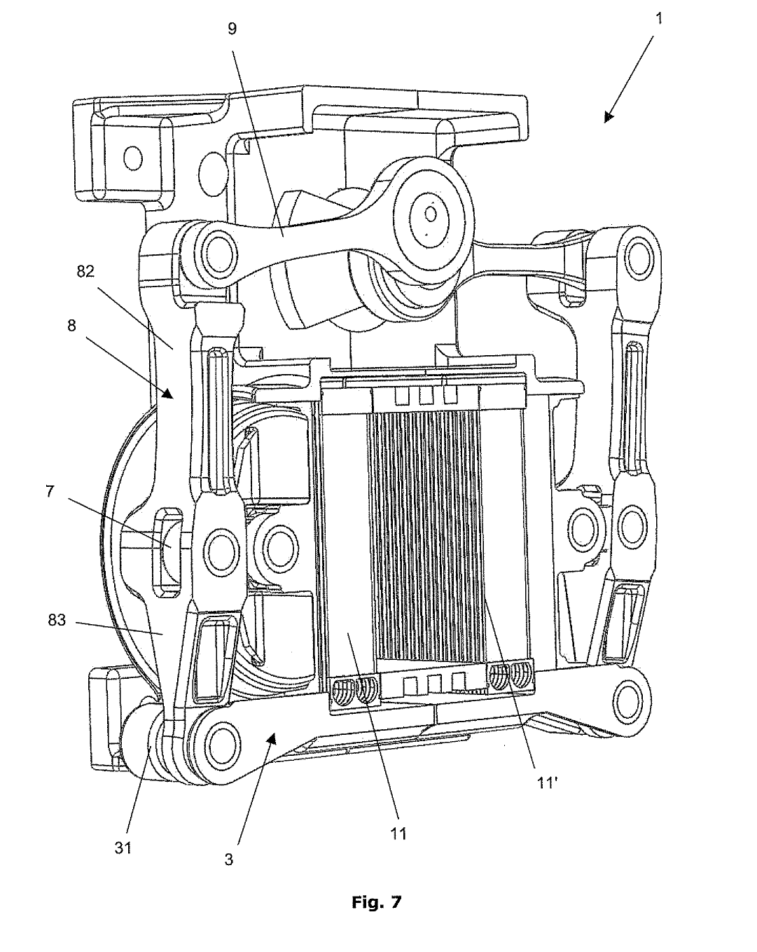

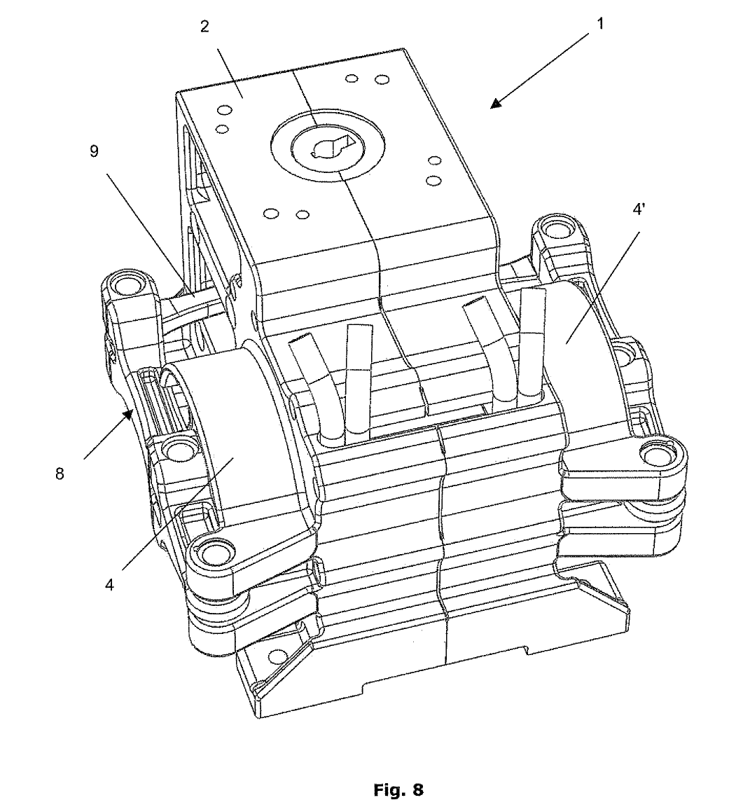

A further embodiment of the invention is shown in FIGS. 6 to 8. In contrast to the embodiment as described above, the oscillating lever 8 is provided without any bent portion. The approximately sinusoidal progression of the piston movement is achieved in such a way that the connecting rod 9 is arranged to be considerably longer than the first connecting rod 7 which connects the oscillating lever 8 with the piston 6. Similarly, the ratio of the two oscillating lever sections 82, 83 of the oscillating lever 8 and the ratio of the length of the first connecting rod 7 to that of the second connecting rod 9 have an influence on the progression of the piston.

The oscillating lever 8 is connected in this embodiment of the invention in an articulated manner with the cylinder housing 3 via a straight nose with the liner 31. As a result of the straight arrangement of the oscillating lever 8, a more compact configuration of the Stirling engine 1 in accordance with the invention can be achieved which is easier to produce.

In this Stirling engine 1, one heat exchanger 11, 11′ with a lamellar structure is also associated with each cylinder half 4, 4′, with a regenerator 12 being arranged between the two heat exchangers 11, 11′. The heat exchangers 11, 11′ are made of a plurality of aluminium cavities on the cooling medium side and wavy ribs on the gas side, similar to a vehicle radiator.

It is understood that the invention is not limited to the embodiment as described above. It has been seen that the Stirling engine in accordance with the invention is especially suitable for use as a heat pump for energy-saving tempering of a house by utilizing a solar power plant for example.

1. A Stirling engine, comprising at least one cylinder in which two pistons are arranged which move counter to one another, with each piston being connected by means of a first connecting rod to an oscillating lever, and the oscillating lever is connected by means of a second connecting rod to the crankshaft, wherein the oscillating lever is connected in an articulated manner with a first end to the second connecting rod, the oscillating lever is pivotably mounted at a second end in the cylinder housing, and the first connecting rod is connected in an articulated manner between the first and second end.

2. A Stirling engine according to claim 1, wherein the oscillating lever is arranged in a straight line, and the first connecting rod is connected in an articulated manner to the oscillating lever, through which the oscillating lever is subdivided into two sections which preferably have different lengths.

3. A Stirling engine according to claim 1, wherein the oscillating lever comprises two sections which are arranged at an angle in relation to one another, with the first connecting rod being connected in an articulated manner to a longer of the two sections.

4. A Stirling engine according to claim 3, wherein the end of the longer section comprises two projections through which the oscillating lever is connected in an articulated manner to the cylinder housing.

5. A Stirling engine according to claim 1, wherein the oscillating lever is provided with an integral arrangement.

6. A Stirling engine according to claim 3, wherein the second connecting rod is provided with a short arrangement, with a length of the second connecting rod preferably being shorter than three times the crank throw.

7. A Stirling engine according to claim 1, wherein each piston is associated with a separate heat exchanger which are arranged spaced from one another in the cylinder housing between the pistons.

8. A Stirling engine according to claim 7, wherein the heat exchanger comprises ribs which are made of aluminium and are spaced from one another via embossed knobs.

9. A Stirling engine according to claim 7, wherein the heat exchanger has a rectangular or square shape.

10. A Stirling engine according to claim 7, wherein a regenerator is arranged between the heat exchangers.

11. A Stirling engine according to claim 1, wherein the cylinder plus pistons are arranged in an encapsulated manner.
